(19) United States
(12) Patent Application Publication
(10) Pub. No.: US 2008/0016068 A1
(43) Pub. Date: Jan. 17, 2008

(54) Media-personality information search system, media-personality information acquiring apparatus, media-personality information search apparatus, and method and program therefor

(76) Inventors: Tsuyoshi Takagi, Kanagawa (JP); Toshiharu Yabe, Tokyo (JP); Motoki Tsunokawa, Kanagawa (JP); Akihiro Watanabe, Kanagawa (JP)

Correspondence Address: FROMMER LAWRENCE & HAUG LLP, 745 FIFTH AVENUE, NEW YORK, NY, 10151, US

(21) Appl. No.: 11/827,194

(22) Filed: Jul. 11, 2007

(30) Foreign Application Priority Data
Jul. 13, 2006 (JP) P2006-192309

(51) Int. Cl. G06F 7/04

(52) U.S. Cl. 707/6; 707/E17.015

(57) ABSTRACT

A media-personality information acquiring apparatus includes a program keyword acquiring unit configured to acquire keywords contained in information on a program as program keywords, a program genre determining unit configured to determine whether or not a genre of the program is a predetermined genre, a caption keyword acquiring unit configured to acquire keywords contained in captions of the program as caption keywords when the program genre is the predetermined genre, and a media personality information generating unit configured to generate information on media personalities in the program on the basis of the program keywords or the caption keywords.

### CROSS REFERENCES TO RELATED APPLICATIONS

The present invention contains subject matter related to Japanese Patent Application JP 2006-192309 filed in the Japanese Patent Office on Jul. 13, 2006, the entire contents of which are incorporated herein by reference.

### BACKGROUND OF THE INVENTION

1. Field of the Invention

The present invention relates to media-personality information search systems. In particular, the present invention relates to a media-personality information search system for searching for a scene in which a designated media personality appears. The present invention also relates to a media-personality information acquiring apparatus, a media-personality information search apparatus, a processing method for the system and the apparatuses, and a program for causing a computer to execute the method.

2. Description of the Related Art

With the widespread use of moving image recording/playback apparatuses, recording and playback of broadcast programs can readily be performed. However, it difficult for users to find scenes that the users desire to view from among a large number of recorded broadcast programs.

Various techniques have been proposed for searching for desired scenes from video images of broadcast programs. For example, Japanese Unexamined Patent Application Publication No. 2002-44573 discloses an information signal processing apparatus which generates a digest of a news program using a correlation between scenes (see, FIG. 1).

In a search for desired scenes from moving images, it would be convenient if the scenes could be searched for by designating specific people to be searched for such as actors, singers, and athletes. In digital television broadcasts, broadcast signals contain program information and caption information. Thus, by using such information, searching for designated people may be possible.

However, the contents of program information and caption information largely depend on the genres of broadcast programs. For example, in movie programs and drama programs, program information often indicates screen names of actors together with corresponding character names of the actors in the programs, and caption information does not indicate the screen name but the character names of the actors. On the other hand, in sports programs, character names are not considered, and in many cases, names of athletes are not presented in program information but presented only in caption information.

Thus, to search for media personalities on the basis of program information and caption information, it is necessary to take into account the genres of broadcast programs.

### SUMMARY OF THE INVENTION

Accordingly, there is a need for a technique for searching for media personalities on the basis of program information and caption information while taking into account the genres of broadcast programs.

According to an embodiment of the present invention, a media-personality information acquiring apparatus includes a program keyword acquiring unit configured to acquire keywords contained in information on a program as program keywords, a program genre determining unit configured to determine whether or not a genre of the program is a predetermined genre, a caption keyword acquiring unit configured to acquire keywords contained in captions of the program as caption keywords when the program genre is the predetermined genre, and a media personality information generating unit configured to generate information on media personalities in the program on the basis of the program keywords or the caption keywords. With this media-personality information acquiring apparatus, information on media personalities can be generated by extracting keywords from not only program information but also caption information in accordance with the genre of a program.

In the media-personality information acquiring apparatus, the program genre determining unit can determine that the program genre is the predetermined genre if the program keywords do not contain a character name. This is because it is likely that information other than information on character names is acquired from captions of such a program whose program information does not contain a character name.

In the media-personality information acquiring apparatus, the program genre determining unit can determine that the program genre is the predetermined genre if it is determined from the program keywords that the program is a sports program or a news program. This is because it is likely that information on media personalities can be acquired from captions of a sports program or a news program.

In the media-personality information acquiring apparatus, the caption keyword acquiring unit can identify a speaker corresponding to each of the captions of the program on the basis of color information on the captions and reflect a result of the identification on the caption keywords. With this arrangement, an appropriate keyword can be acquired even when a speaker corresponding to a caption is not indicated.

In the media-personality information acquiring apparatus, the media personality information generating unit can include a character name linking portion for linking a name of a media personality to a name of a character of the media personality on the basis of the program keywords. With this arrangement, the name of a performer can be associated with the name of a character of the performer in a program.

The media-personality information acquiring apparatus can further include a display control unit configured to perform control so that the media personality information generated by the media personality information generating unit is displayed together with the program information on a display unit.

In the media-personality information acquiring apparatus, the display control unit can perform control so that media personality information corresponding to a program selected from the displayed program information is displayed on the display unit.

In the media-personality information acquiring apparatus, the display control unit can further includes a searching portion for searching for a scene in which the media personality selected from the displayed media personality information appears.

According to an embodiment of the present invention, a media-personality information search apparatus includes an operation receiving unit configured to receive a search operation relating to a media personality, a program searching unit configured to search for a program related to the media personality corresponding to the search operation, from information on media personalities in programs, a program genre determining unit configured to determine whether the genre of the searched program is a first genre or a second genre, and a caption searching unit configured to search for the name of the media personality corresponding to the search operation from keywords contained in captions of the searched program if the program genre is the first genre, and search for the name of a character of the media personality corresponding to the search operation from keywords contained in the captions of the searched program if the program genre is the second program, so as to specify a scene in which the media personality corresponding to the search operation appears. With this media-personality information search apparatus, a media-personality can be searched for by the name of the media-personality or the name of a character of the media-personality in accordance with a program genre.

In the media-personality information search apparatus, the program genre determining unit can determine the program genre to be the first genre if a media personality name is presented in captions, and determines the program genre to be the second genre if a character name of a media personality is presented in captions. For example, the genre of the program can be determined to be the first genre if the program is a sports program, a variety program, or a news program, and the genre of the program can be determined to be the second genre if the program is a movie program or a drama program.

According to an embodiment of the present invention, a media-personality information search system includes a program keyword acquiring unit configured to acquire keywords contained in information on a program as program keywords, a first program genre determining unit configured to determine whether or not a genre of the program is a predetermined genre, a caption keyword acquiring unit configured to acquire keywords contained in captions of the program as caption keywords if the program genre is the predetermined genre, a media personality information generating unit configured to generate information on media personalities in the program on the basis of the program keywords or the caption keywords, an operation receiving unit configured to receive a search operation relating to a media personality, a program searching unit configured to search for a program related to the media personality corresponding to the search operation, from the information on media personalities, a second program genre determining unit configured to determine whether the genre of the searched program is the first genre or the second genre, and a caption searching unit configured to search for the name of the media personality corresponding to the search operation from keywords contained in captions of the searched program if the program genre is the first genre, and search for the name of a character of the media personality corresponding to the search operation from keywords contained in the captions of the searched program if the program genre is the second genre, so as to specify a scene in which the media personality corresponding to the search operation appears. With this media-personality information search system, information on media personalities can be generated by extracting keywords from not only program information but also caption information in accordance with the genre of a program, and on the basis of this media personality information, a media personality can be searched for by the name of the media personality or by the name of a character of the media personality in accordance with the genre of a program related to the media personality.

According to the present invention, media personalities can advantageously be searched for on the basis of program information and caption information while the genres of broadcast programs are taken into account.

### BRIEF DESCRIPTION OF THE DRAWINGS

FIG. 1 illustrates a configuration of a media-personality information acquiring apparatus according to an embodiment of the present invention;

FIG. 2 illustrates a configuration of a program information file 510 according to an embodiment of the present invention;

FIG. 3 illustrates an example of content of a program description according to an embodiment of the present invention;

FIG. 4 illustrates a configuration of a caption information file according to an embodiment of the present invention;

FIG. 5 illustrates a configuration of a caption index file according to an embodiment of the present invention;

FIG. 6 illustrates a configuration of a media personality information file according to an embodiment of the present invention;

FIG. 7 illustrates configuration of a media-personality information search apparatus according to an embodiment of the present invention;

FIG. 8 illustrates an example of a screen displayed when a program is selected according to an embodiment of the present invention;

FIG. 9 illustrates an example of a screen displayed when a media personality is selected according to an embodiment of the present invention;

FIG. 10 is a sequence diagram illustrating an example of an operation procedure performed when media personality information is acquired according to an embodiment of the present invention;

FIG. 11 is a sequence diagram illustrating an example of an operation procedure performed when a search for media personality information is performed; and

FIG. 12 is a sequence diagram illustrating another example of an operation procedure performed when a search for media personality information is performed.

### DESCRIPTION OF THE PREFERRED EMBODIMENTS

In the following, the preferred embodiments of the present invention will be described in detail with reference to the accompanying drawings.

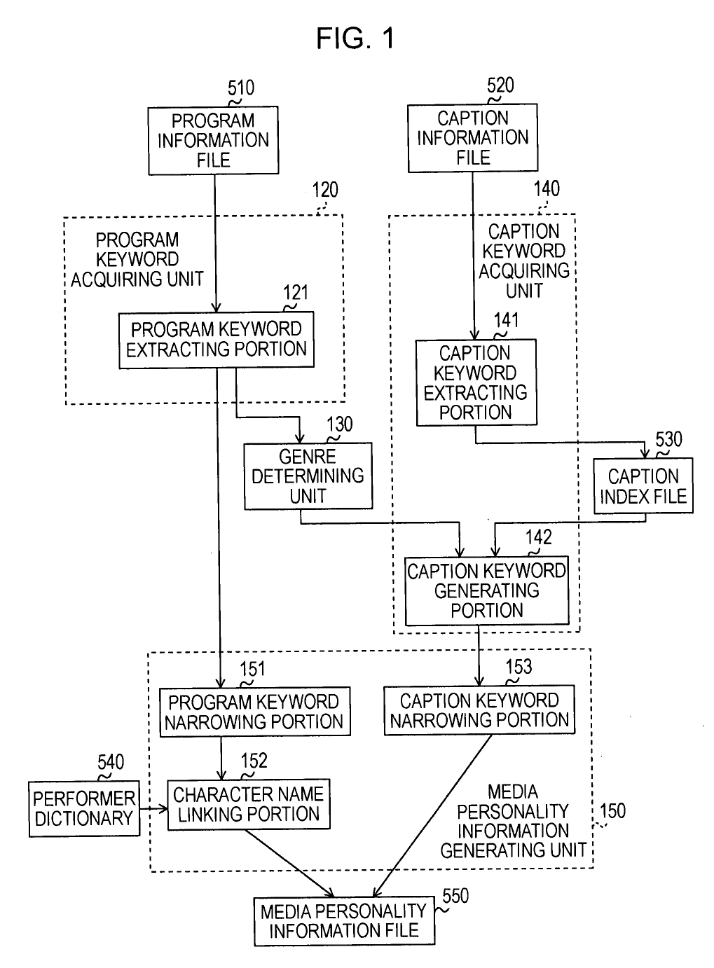

FIG. 1 illustrates an example of a configuration of a media-personality information acquiring apparatus according to an embodiment of the present invention. This media-personality information acquiring apparatus has a program keyword acquiring unit 120, a genre determining unit 130, a caption keyword acquiring unit 140, and a media personality information generating unit 150. The media-personality information acquiring apparatus receives input from a program information file 510 and a caption information file 520 and outputs a caption index file 530 and a media personality information file 550.

The program keyword acquiring unit 120 has a program keyword extracting portion 121 and acquires keywords contained in the program information file 510. The program information file 510 stores information on programs such as the titles and detailed descriptions of the programs, as will be described below. In digital television broadcasts, the content of the program information file 510 is stored as an Event Information Table (EIT) in Service Information (SI) in an MPEG (Moving Picture Experts Group)-2 transport stream.

The program keyword extracting portion 121 performs morphological analysis on the content of each program contained in the program information file 510 to extract keywords (hereinafter referred to as “program keywords”).

Morphological analysis herein refers to a process of separating a text into the smallest units called morphemes and analyzing the attributes of the individual morphemes. Such attributes generally include word classes such as “verb”, “adjective”, and “noun”. In this embodiment, nouns can be categorized into “common noun”, “place name”, “person name”, “organization name”, “proper noun”, etc. The program keyword acquiring unit 120 provides the genre determining unit 130 and the media personality information generating unit 150 with program keywords and corresponding attributes.

The genre determining unit 130 determines a program genre for the program keywords acquired by the program keyword acquiring unit 120 from the program information. In digital television broadcasts, program genres can be acquired by referring to a content descriptor in an EIT. The program genre may also be estimated from the program keywords acquired by the program keyword acquiring unit 120 from the program information.

The program genres includes, for example, “movie”, “drama”, “sports”, “variety”, and “news”. If sufficient information on a media personality is not obtained from only the program information file 510, the genre determining unit 130 determines that it is necessary to obtain keywords from the caption information file 520. A media personality herein refers to a person who appears on a program, such as an entertainer, an athlete, and a newscaster. Examples of such program genres for which the keywords from the caption information file 520 are necessary include “sports” and “news”, for example.

For example, in many cases, only names of teams are contained in program information of a sports program, and names of athletes are contained only in caption information. In the case of a news program, only names of announcers are contained in program information, and names of people appearing on the news program are contained only in caption information. For such program genres, the genre determining unit 130 notifies the caption keyword acquiring unit 140 that keywords need to be acquired from the caption information.

The caption keyword acquiring unit 140 has a caption keyword extracting portion 141 and a caption keyword generating portion 142 and acquires keywords contained in the caption information file 520. The caption information file 520 stores captions of each program such as closed captions in time series, as will be described below. In digital television broadcasts, the content of caption information file 520 is stored in a MPEG-2 transport stream together with audio information and video information.

The caption keyword extracting portion 141 performs morphological analysis on the content of a caption contained in the caption information file 520 to extract keywords (hereinafter referred to as “caption keywords”). The caption keywords extracted by the caption keyword extracting portion 141 are stored in the caption index file 530. The caption index file 530 stores the caption keywords together with corresponding attributes as pairs, as will be described below.

When the genre determining unit 130 determines that keywords from the caption information file 520 are necessary, the caption keyword generating portion 142 acquires the keywords from the caption information file 520 and generates caption keywords. The caption keywords generated by the caption keyword generating portion 142 are supplied to the media personality information generating unit 150.

The media personality information generating unit 150 generates information on media personalities in programs, on the basis of the program keywords supplied by the program keyword acquiring unit 120 and the caption keywords supplied as necessary by the caption keyword acquiring unit 140. The media personality information generating unit 150 has a program keyword narrowing portion 151, a character name linking portion 152, and a caption keyword narrowing portion 153.

The program keyword narrowing portion 151 narrows down the program keywords supplied by the program keyword acquiring unit 120 to keywords relating to “person”, “last name”, and “first name”. The keywords narrowed down by the program keyword narrowing portion 151 are supplied to the character name linking portion 152.

The character name linking portion 152 links a name of a media personality (media personality name) to a corresponding name of a character (character name) in a program, on the basis of the program keywords narrowed down by the program keyword narrowing portion 151. When the media personality is an actor or the like, the media personality name may be the screen name of the media personality or may be his or her real name, and the character name in the program may be the name of a person (character) whom the media personality performs, if the program is a movie program or a drama program.

Note that a media personality name and a character name can be distinguished from each other on the basis of a configuration of program information. However, to increase the precision of the distinction, for example, a performer dictionary 540 can be employed. Thus, if a name of a person is found in the performer dictionary 540, the name can be regarded as the screen name of the person and not as a character name.

The media personality name (screen name) and the corresponding character name that are linked by the character name linking portion 152 are stored together with a corresponding program identifier as media personality information in the media personality information file 550.

The caption keyword narrowing portion 153 narrows down the caption keywords supplied by the caption keyword acquiring unit 140 to keywords relating to “person”. The caption keywords can include either media personality names or character names, depending on the genre of the program. For example, in general, character names are used in movie programs and drama programs, and media personality names are used in sports programs and news programs. The caption keywords narrowed down by the caption keyword narrowing portion 153, i.e., media personality names or character names, are stored together with corresponding program identifiers as media personality information in the media personality information file 550.

As described above, in the media-personality information acquiring apparatus according to an embodiment of the present invention, pairs of media personality names and character names, or either media personality names or character names are stored together with corresponding program identifiers in the media personality information file 550.

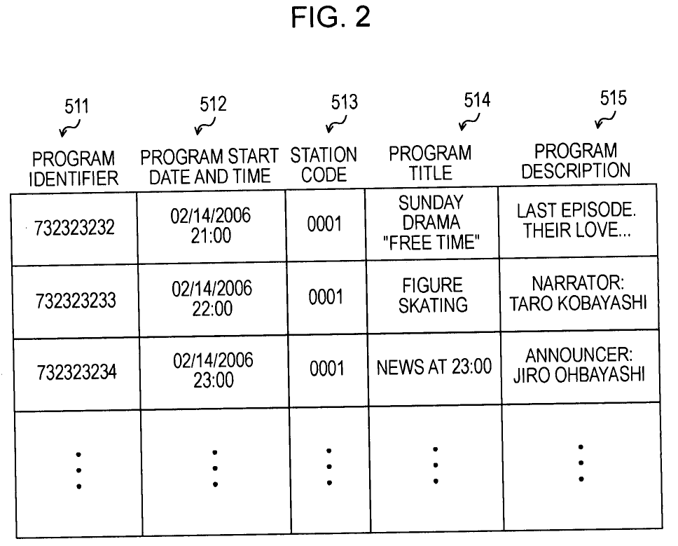

FIG. 2 illustrates an example of a configuration of the program information file 510 according to an embodiment of the present invention. In the program information file 510, one record is allocated for each program. Each record contains a program identifier 511, a program start date and time 512, a station code 513, a program title 514, and a program description 515.

The program identifier 511 indicates an identifier for allowing a corresponding program to be uniquely identified. The program start date and time 512 indicates the date and time when the broadcast of the program starts. The station code 513 indicates a code of a broadcast station that broadcasts the program. Note that a station code needs to be assigned to each broadcast station beforehand.

The program title 514 indicates the title of the program. The program description 515 indicates a detailed description of the content of the program. The format of the program description 515 is not particularly standardized. However, the format can roughly be classified as follows.

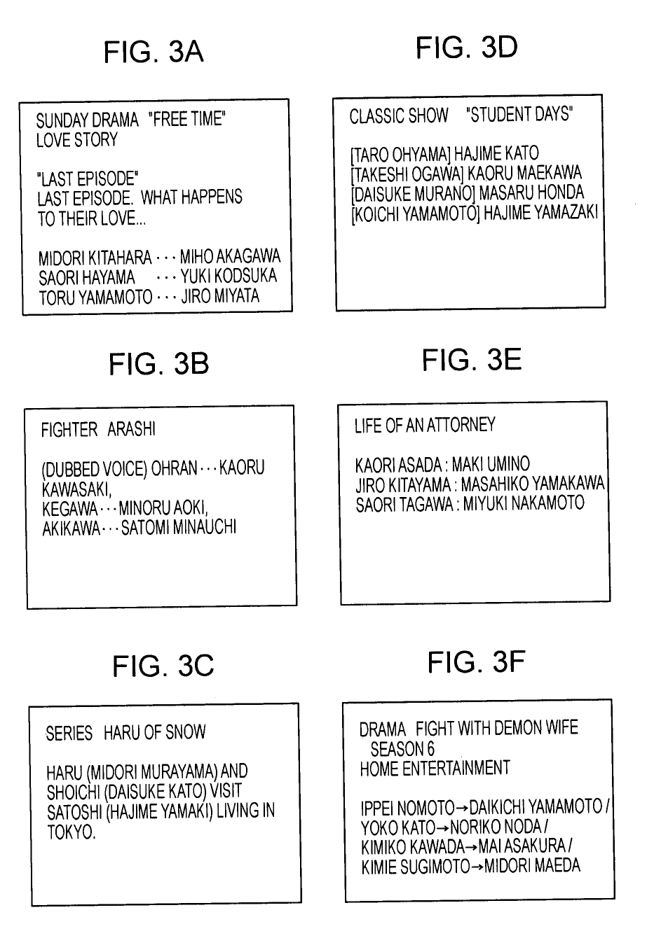

Referring to FIGS. 3A to 3F, examples of content of the program description 515 according to an embodiment of the present invention are illustrated. In the case of movie programs and drama programs, the program description 515 is often created in the following formats.

FIG. 3A illustrates an example of a format in which a character name and a corresponding media personality name are coupled by a symbol “•”. In general, the character name is followed by the media personality name. In this example, the number of the symbols “•” is three, but is not limited to being three. FIG. 3B illustrates an example of a format in which a character name and a corresponding media personality name are coupled by a symbol “ . . . ”. Also in this case, the character name is generally followed by the media personality name. FIG. 3C illustrates an example of a format in which a correspondence relationship between a character name and a corresponding media personality name are embedded in the content description of a program. In this example, the content is described on the basis of character names, and the corresponding media personality names are provided in parentheses.

FIG. 3D illustrates an example of a format in which a character name is enclosed by brackets and followed by a corresponding media personality name. FIG. 3E illustrates an example of a format in which a character name and a media personality name are coupled by a symbol “:”. Similarly to the examples of FIGS. 3A and 3B, a character name is generally followed by a corresponding media personality name. The symbol “:” may be a single-byte or double-byte character. FIG. 3F illustrates an example of a format in which a media personality name and a character name are coupled by a symbol “→” and each pair of a media personality name and a character name are separated by a symbol “/”. In this case, the media personality name is generally followed by the character name.

Thus, when the program keyword narrowing portion 151 in the media personality information generating unit 150 extracts keywords related to “person”, “last name”, “first name”, and “symbol”, it is preferable that those symbols described in the examples of FIGS. 3A to 3F are extracted. It is also preferable that the character name linking portion 152 estimates that names placed before the other symbols than “→” are character names and names placed after symbols other than “→” are media personality names. In contrast, it is preferable that the character name linking portion 152 estimates that names placed before the symbol “→” are media personality names and names placed after the symbol “→” are character names.

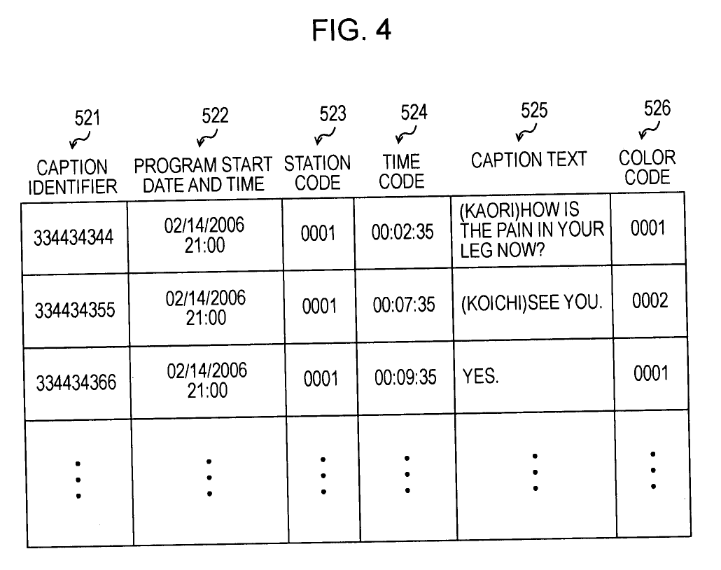

FIG. 4 illustrates an example of a configuration of the caption information file 520 according to an embodiment of the present invention. In this caption information file 520, one record is allocated for each caption. Each record stores a caption identifier 521, a program start date and time 522, a station code 523, a time code 524, a caption text 525, and a color code 526.

The caption identifier 521 indicates an identifier allowing a caption to be uniquely identified. The program start date and time 522 indicates the date and time when the broadcast of a program containing the caption starts. The station code 523 indicates a code of a broadcast station that broadcasts the program containing the caption. The time code 524 indicates a time point at which the caption is presented during the program. The time code 524 may be presented as an elapsed time to the second since the beginning of the program. However the time code 524 is not limited to being such an elapsed time.

The caption text 525 indicates the content (text) of a caption. The caption keyword extracting portion 141 performs keyword extraction on the caption text 525. The color code 526 indicates a code of a color in which the caption is presented. The color code 526 is set when the caption is created, such that different colors are assigned to individual speakers.

In the caption text 525, the character name of each speaker is often placed in parentheses at the beginning of a caption. The caption keyword extracting portion 141 extracts the character name in parentheses as a keyword. However, the name of a speaker may not be provided for every caption and may be omitted for the second time and thereafter. Thus, when a speaker name is not provided in the caption text 525, the caption keyword extracting portion 141 preferably refers to the color code 526 to obtain the omitted speaker name so as to extract keywords.

For example, in the caption information file 520 illustrated in FIG. 4, no speaker name is provided for the caption text 525 “Yes.” indicated in the third row of the figure. However, the color code 526 corresponding to the caption text 525 “Yes.” is the same as the color code 526 corresponding to the caption text 525 indicated in the first row of the figure. Since the speaker corresponding to the caption text 525 in the first row is “Kaori”, the caption keyword extracting portion 141 can also extracts a keyword of the caption text 525 of the third row as “(Kaori)Yes.” Thus, a keyword relating to a character name “Kaori” can be extracted also for a scene corresponding to the time code 524 of “00:09:35”.

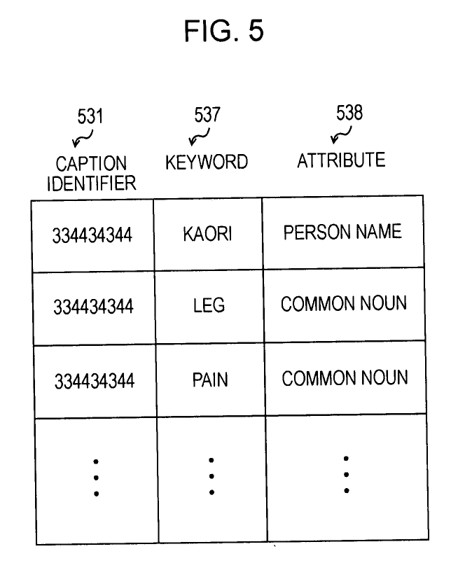

FIG. 5 illustrates an example of a configuration of the caption index file 530 according to an embodiment of the present invention. In this caption index file 530, which is an index file of caption keywords, one record is allocated for each caption keyword. Each record stores a caption identifier 531, a keyword 537, and an attribute 538.

The caption identifier 531 is an identifier allowing a caption corresponding to a caption keyword to be uniquely identified. Thus, the same caption identifier 531 is provided for individual caption keywords extracted from the same caption. The keyword 537 indicates the content of the caption keyword. The attribute 538 indicates the attribute of the caption keyword. The attribute 538 is based on morphological analysis and can include more detailed information than general word classes.

The caption index file 530 is not only referred to by the caption keyword generating portion 142 but also used in a search for a caption, as will be described below. This allows a rapid search for a media personality name or a character name from captions.

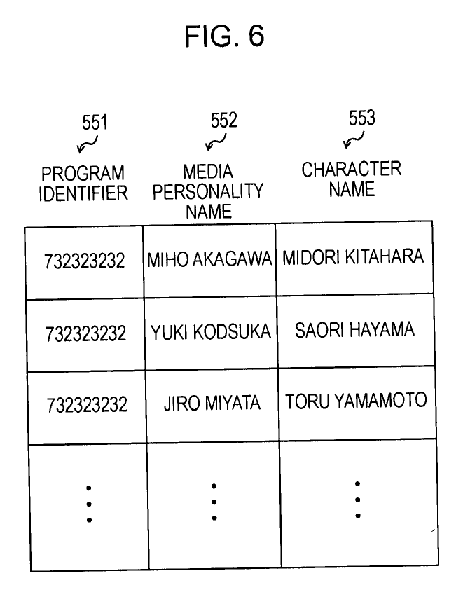

FIG. 6 illustrates an example of a configuration of the media personality information file 550 according to an embodiment of the present invention. In the media personality information file 550, which is a file storing information on media personalities, one record is allocated for each media personality. Each record stores a program identifier 551, a media personality name, 552, and a character name 553.

The program identifier 551 indicates an identifier allowing a program on which a corresponding media personality appears to be uniquely identified. The media personality name 552 indicates the name of the media personality (screen name, etc.). The character name 553 indicates the character name of the media personality in the program.

For a program such as a movie program or a drama program, in which character names are used, the character name of the media personality is indicated as the character name 553. However, for a program such as a sports program or a news program, in which character names are not used, no character name is indicated.

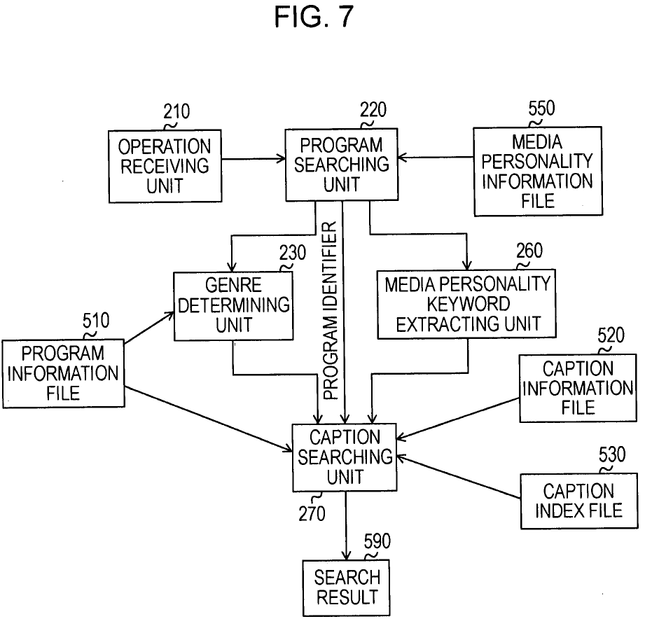

FIG. 7 illustrates an example of a configuration of a media-personality information search apparatus according to an embodiment of the present invention. This media-personality information search apparatus has an operation receiving unit 210, a program searching unit 220, a genre determining unit 230, a media personality keyword extracting unit 260, and a caption searching unit 270. The media-personality information search apparatus receives input of the program information file 510, the caption information file 520, the caption index file 530, and the media personality information file 550 and outputs a search result 590.

The operation receiving unit 210 serves as a user interface for receiving a search operation performed by a user for a search relating to a media personality. The search operation includes input of the name of the media personality to be searched for. The user may designate a program to be searched for or all programs may be searched for.

The program searching unit 220 searches for the media personality name which has been set as a search object in the operation receiving unit 210, in the media personality information file 550. In the media personality information file 550, the media personality information generating unit 150 stores a pair of a media personality name and a character name or either a media personality name or a character name is stored together with a corresponding program identifier as one record. The program searching unit 220 searches for the media personality name to be searched for in the media personality information file 550 and outputs a corresponding record.

The genre determining unit 230 determines the genre of a program searched by the program searching unit 220. In digital television broadcasts, the program genre can be acquired by referring to a content descriptor in an EIT or estimated from the content of a record acquired by the program searching unit 220 from the media personality information file 550.

Program genres to be determined by the genre determining unit 230 include, for example, “movie”, “drama”, “sports”, “variety”, and “news”, as in the case of the genre determining unit 130. The genre determining unit 230 determines whether a media personality is searched for by a media personality name or a corresponding character name in a search performed by the caption searching unit 270.

For example, in a movie program and a drama program, character names are often presented in captions. On the other hand, in other programs including a spots program, a variety program, and a news program, media personality names are presented in captions. Thus, the genre determining unit 230 determines that the search is performed on the basis of the character name of the media personality if the program to be searched for is a movie program or a drama program. On the other hand, the genre determining unit 230 determines that the search is performed on the basis of the media personality name if the program to be searched for is a sports program, a variety program, or a news program.

The media personality keyword extracting unit 260 extracts a media personality name or a character name from a record supplied by the program searching unit 220 as media personality keywords. In the record supplied by the program searching unit 220, a media personality name or a character name is recorded with the first name and last name not being separated. The media personality keyword extracting unit 260 divides such a media personality name or character name into “name”, “first name”, and “last name”, and sets the divided words as media personality keywords.

The caption searching unit 270 refers to the caption index file 530 on the basis of media personality keywords supplied by the media personality keyword extracting unit 260 and outputs the time code 524 of a corresponding caption. At this time, the caption searching unit 270 performs a search by a media personality name or a character name in accordance with a result of determination performed by the genre determining unit 230. The time code 524 of the caption can be derived from the caption identifier 521 in the caption information file 520 which corresponds to the caption identifier 531 corresponding to a record searched by the caption searching unit 270.

In addition, the caption searching unit 270 receives from the program searching unit 220 program identifiers to be searched for so as to narrow down search results using the program identifiers. Specifically, the caption searching unit 270 derives the program start date and time 512 and station code 513 corresponding to each of the program identifiers supplied by the program searching unit 220 from the program identifier 511 in the program information file 510 which corresponds to each of the program identifiers. Then, the caption searching unit 270 refers to the caption information file 520 to search for the program start date and time 522 and the station code 523 which correspond to the program start date and time 512 and station code 513, respectively, so as to acquire a range of the caption identifiers 521. Thus, by narrowing down the search results (time codes 524) so that the search results correspond to the individual caption identifiers within the acquired range, the time codes in the program to be searched for can be generated as the search result 590. The program title can be acquired from the program title 514 in the program information file 510.

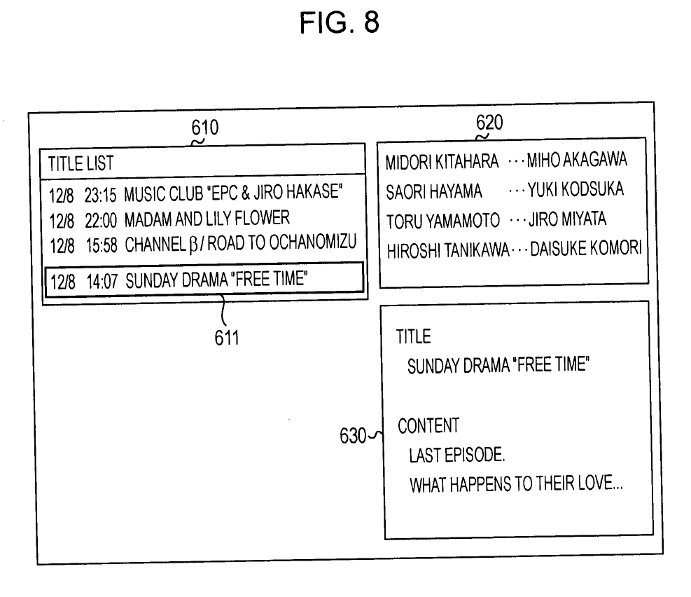

FIG. 8 illustrates an example of a screen displayed when a program is selected, according to an embodiment of the present invention. As illustrated in the figure, a title list 610 is displayed in the upper left of the screen. This title list 610 allows a user to select a program to be searched through by moving a selection box 611 up or down. In this example, the selection box 611 is placed at the fourth item from the top of the title list 610 so that the corresponding program is selected. Information 620 relating to media personalities (hereinafter referred to as media personality information 620) corresponding to the selected program is displayed in the upper right of the screen, and information 630 relating to the content of the program (hereinafter referred to as program information 630) is displayed on the lower right of the screen.

When the selection of the item is instructed by the user, a corresponding media personality can be selected in the media personality information 620, as described below.

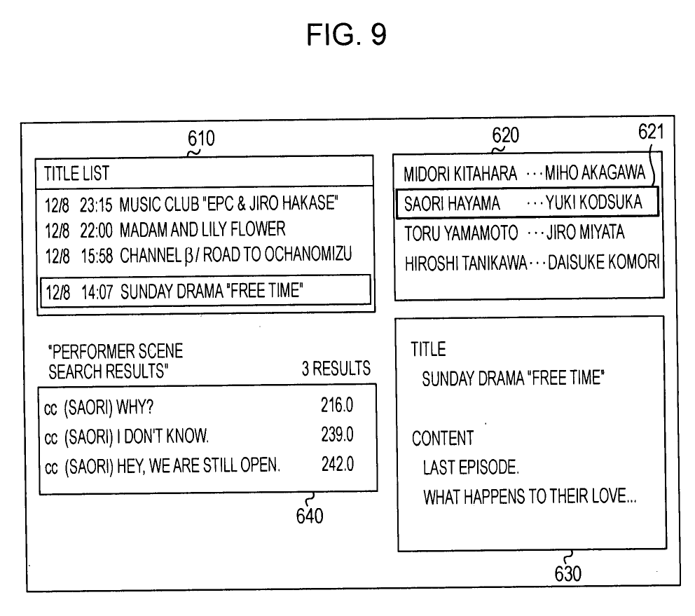

FIG. 9 illustrates an example of a screen displayed when a media personality is selected. A media personality to be searched for can be selected by moving a selection box 621 up and down in the media personality information 620. In this example, the selection box 621 is placed at the second item from the top of the media personality information 620, so that the corresponding media personality is selected.

Thus, a scene in which the selected media personality performs his or her character can be searched for, and a result of the search is displayed in a search result 640 in the lower left of the screen. In this example, three captions are displayed together with corresponding time codes in the search result 640.

As described above, a list of media personalities corresponding to a program on the program list is displayed so that a user selects a media personality to be searched for from among the media personality list. With this arrangement, it is no longer necessary for the user to enter the name of a media personality to be searched for. In the above example, the case is described where a search is performed on the basis of a program corresponding to a media personality list. However, a media personality can be searched for by searching through all programs.

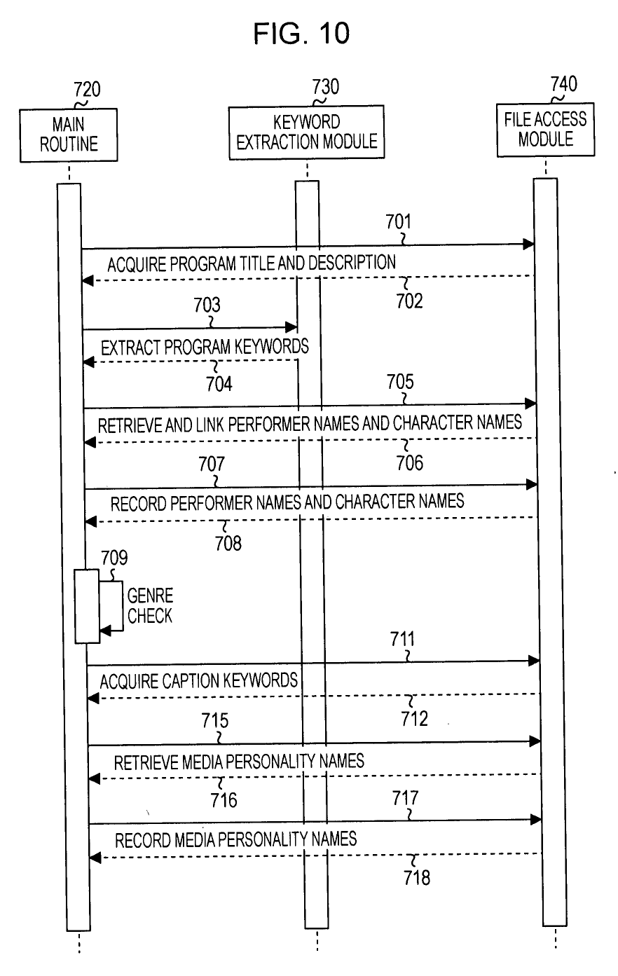

FIG. 10 is a sequence diagram illustrating an example of an operation procedure to be performed when media personality information is acquired according to an embodiment of the present invention. Here, it is assumed that a keyword extraction module 730 and a file access module 740 as well as a main routine 720 are provided as programs executed on a computer. In this example, the keyword extraction module 730 serves as a keyword extraction engine, and the file access module 740 serves to access each file while maintaining a relationship between files.

The file access module 740 first accesses the program information file 510 to acquire the program title 514 and the program description 515 of a program (701) and returns the operation result to the main routine 720 (702). Then, the keyword extraction module 730 extracts program keywords from the program description 515 (703) and returns the operation result to the main routine 720 (704). The file access module 740 retrieves media personality names and character names and links the media personality name to the corresponding character name (705) and returns the operation result to the main routine 720 (706). Thus, the file access module 740 registers the media personality names and the corresponding character names in the media personality information file 550 (707). A notification of success or failure of the registration is returned to the main routine 720 (708).

Subsequently, in the main routine 720, the genre of the program is determined (709). If the genre of the program is determined to be such a genre for which keywords are need to be acquired from caption information, the file access module 740 accesses the caption index file 530 to acquire caption keywords (711) and returns the operation result to the main routine 720 (712). Then, the file access module 740 retrieves media personality names (715) and returns the operation result to the main routine 720 (716). Thus, the file access module 740 registers the media personality names in the media personality information file 550 (717). A notification of success or failure of the registration is returned to the main routine 720 (718).

Note that in this example, it is assumed that the caption index file 530 has been generated beforehand.

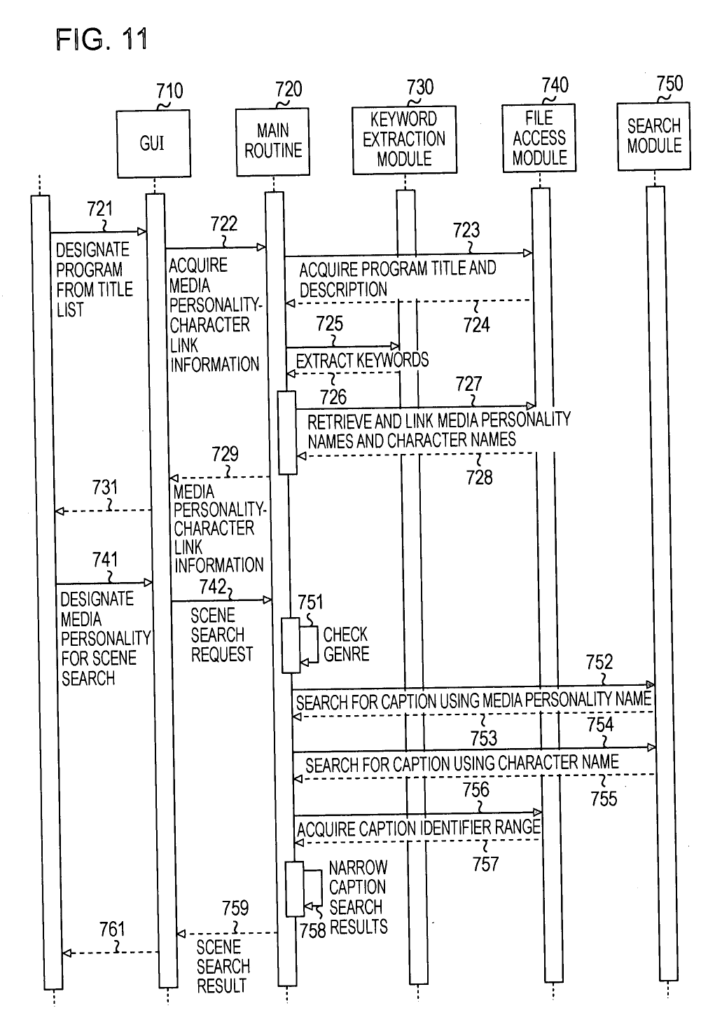

FIG. 11 is a sequence diagram illustrating an example of an operation procedure performed when media personality information is searched for, according to an embodiment of the present invention. This example illustrates a case where a program to be searched through has been specified beforehand. It is herein assumed that in addition to the main routine 720, a GUI (graphical user interface) 710, the keyword extraction module 730, the file access module 740, and a search module 750 are provided as programs to be executed on a computer. In this example, similarly to the example of FIG. 10, the keyword extraction module 730 serves as a keyword extraction engine, and the file access module 740 serves to access each file while maintaining a relationship between files. The search module 750 serves as a search engine.

When a program is designated by a user through the title list 610 (see, FIG. 8) which is displayed in the GUI 710 (721), the designation is transferred to the main routine 720 (722), and the file access module 740 accesses the program information file 510 (723). Thus, the program title 514 and the program description 515 of the program are acquired (724).

Then, the keyword extraction module 730 extracts program keywords from the program description 515 (725) and returns the operation result to the main routine 720 (726). Subsequently, the file access module 740 retrieves media personality names and character names and links the media personality names to the corresponding character names (727) and returns the operation result to the main routine 720 (728). As a result, information indicating the linkage of the media personality names and the corresponding character names is displayed in the GUI (729) so as to be presented to the user (731).

When the user designates a media personality in the media personality information 620 (see, FIG. 9) displayed in the GUI 710 (741), a request for a search for the media personality is transferred to the main routine 720 (742), and the genre of the program that has been designated by the user (721) is determined in the main routine 720 (751). As a result, if the designated program is a sport program, a variety program, a news program, or the like, in which media personality names are presented in captions, the search module 750 searches through the caption index file 530 using the media personality name as a keyword (752). On the other hand, if the designated program is a movie program, a drama program, or the like, in which character names are presented in captions, the search module 750 searches through the caption index file 530 using the character name of the media personality as a keyword (754). In either case, the search module 750 returns the operation result to the main routine 720 (753 or 755).

Then, the file access module 740 narrows down a range of caption identifiers on the basis of a correspondence relationship between the caption information file 520 and the program information file 510 (756), and returns the operation result to the main routine 720 (757). Thus, the search results for the caption index file 530 are narrowed down (758). The search results are displayed in the GUI (759) so as to be presented to the user (761).

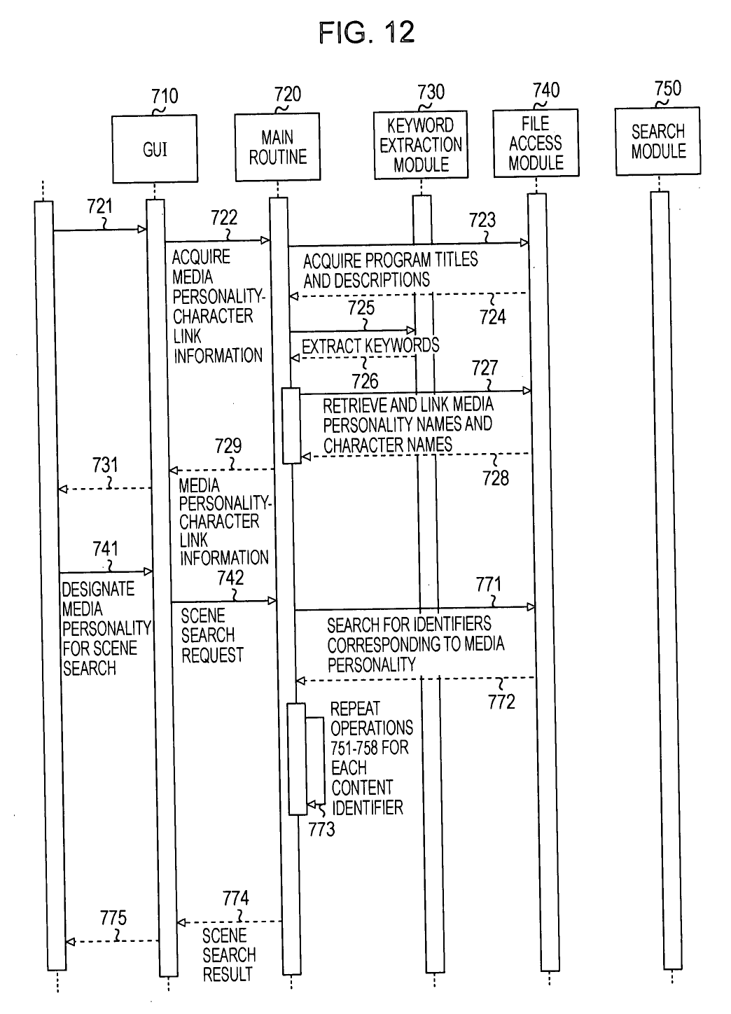

FIG. 12 is a sequence diagram illustrating another example of an operation procedure to be performed when media personality information is searched for. In this example, no program to be searched through is designated, and all programs are applied to the search.

In this example, programs to be executed on a computer are similar to those in the example of FIG. 11. In addition, the operation procedure from the operations (722) to (742) is similarly performed.

When the main routine 720 receives a search request, the file access module 740 searches through the media personality information file 550 to acquire program identifiers of programs in which the media personality appears (771) and the returns the operation result to the main routine 720 (772). For each of the program identifiers, the operation procedure from (751) to (758) described using FIG. 11 is performed (773). Thus, the search results obtained from all programs are displayed in the GUI 710 (774) so as to be presented to the user (775).

As described above, according to an embodiment of the present invention, in generating the media personality information file 550, the content of the caption information file 520 is also reflected on the media personality information file 550 if the genre determining unit 130 determines the genre of a program to be a sports program or a news program. With this arrangement, media personality information can be obtained which could not be extracted if only the content of the program information file 510 were used.

In addition, when scenes in a program in which a media personality appears are searched for, the caption index file 530 is searched through by the name of the media personality if the genre determining unit 230 determines the genre of the program to be “sports”, “variety”, or “news”. On the other hand, the caption index file 530 is searched through by a character name of the media personality if the genre determining unit 230 determines the genre of the program to be “movie” or “drama”. This arrangement allows a user to precisely search for scenes where a desired media personality appears.

It should be understood that the above embodiments of the present invention illustrate examples for implementing the present invention. The examples illustrated in the embodiments correspond to elements in the claims. However, the embodiments of the present invention are not limited to these examples and various modifications may be made without departing from the scope of the present invention.

Specifically, according to an aspect of the present invention, a program keyword acquiring unit corresponds, for example, to the program keyword acquiring unit 120; a program genre determining unit corresponds, for example, to the genre determining unit 130; a caption keyword acquiring unit corresponds, for example, to the caption keyword acquiring unit 140; and a media personality information generating unit corresponds, for example, to the media personality information generating unit 150.

According to an aspect of the present invention, an operation receiving unit corresponds, for example, to the operation receiving unit 210; a program searching unit corresponds, for example, to the program searching unit 220; a program genre determining unit corresponds, for example, to the genre determining unit 230; and a caption searching unit corresponds, for example, to the caption searching unit 270.

According to an aspect of the present invention, a program keyword acquiring unit corresponds, for example, to the program keyword acquiring unit 120; a first program genre determining unit corresponds, for example, to the genre determining unit 130; a caption keyword acquiring unit corresponds, for example, to the caption keyword acquiring unit 140; a media personality information generating unit corresponds, for example, to the media personality information generating unit 150; an operation receiving unit corresponds, for example, to the operation receiving unit 210; a program searching unit corresponds, for example, to the program searching unit 220; a second program genre determining unit corresponds, for example, to the genre determining unit 230; and a caption searching unit corresponds, for example, to the caption searching unit 270.

According to an aspect of the present invention, a program keyword acquiring step corresponds, for example, to the operation (703); a program genre determining step corresponds, for example, to the operation (709); a caption keyword acquiring step corresponds, for example, to the operation (711); and a media personality information generating step corresponds, for example, to the operation (715).

According to an aspect of the present invention, an operation receiving step corresponds, for example, to the operation (741); a program searching step corresponds, for example, to the operation (771); a program genre determining step corresponds, for example, to the operation (751); and a caption searching step corresponds, for example, to the operations (752) to (758).

The operation steps described in the above embodiments may be considered as a method including a series of operation steps or as a program for causing a computer to execute the series of operation steps or a recording medium for storing the program.

It should be understood by those skilled in the art that various modifications, combinations, sub-combinations and alterations may occur depending on design requirements and other factors insofar as they are within the scope of the appended claims or the equivalents thereof.

What is claimed is:

1. A media-personality information acquiring apparatus comprising:
a program keyword acquiring unit configured to acquire keywords contained in information on a program as program keywords;
a program genre determining unit configured to determine whether or not a genre of the program is a predetermined genre;
a caption keyword acquiring unit configured to acquire keywords contained in captions of the program as caption keywords when the program genre is the predetermined genre; and
a media personality information generating unit configured to generate information on media personalities in the program on the basis of the program keywords or the caption keywords.

2. The media-personality information acquiring apparatus of claim 1,
wherein the program genre determining unit determines that the program genre is the predetermined genre if the program keywords do not contain a character name.

3. The media-personality information acquiring apparatus of claim 1,
wherein the program genre determining unit determines that the program genre is the predetermined genre if it is determined from the program keywords that the program is a sports program or a news program.

4. The media-personality information acquiring apparatus of claim 1,
wherein the caption keyword acquiring unit identifies a speaker corresponding to each of the captions of the program on the basis of color information on the captions and reflects a result of the identification on the caption keywords.

5. The media-personality information acquiring apparatus of claim 1,
wherein the media personality information generating unit includes a character name linking portion for linking a name of a media personality to a name of a character of the media personality on the basis of the program keywords.

6. The media-personality information acquiring apparatus of claim 1, further comprising a display control unit configured to perform control so that the media personality information generated by the media personality information generating unit is displayed together with the program information on a display unit.

7. The media-personality information acquiring apparatus of claim 6,
wherein the display control unit performs control so that media personality information corresponding to a program selected from the displayed program information is displayed on the display unit.

8. The media-personality information acquiring apparatus of claim 6,
wherein the display control unit further includes a searching portion for searching for a scene in which the media personality selected from the displayed media personality information appears.

9. A media-personality information search apparatus comprising:
an operation receiving unit configured to receive a search operation relating to a media personality;
a program searching unit configured to search for a program related to the media personality corresponding to the search operation, from information on media personalities in programs;
a program genre determining unit configured to determine whether the genre of the searched program is a first genre or a second genre; and
a caption searching unit configured to search for the name of the media personality corresponding to the search operation from keywords contained in captions of the searched program if the program genre is the first genre, and search for the name of a character of the media personality corresponding to the search operation from keywords contained in the captions of the searched program if the program genre is the second program, so as to specify a scene in which the media personality corresponding to the search operation appears.

10. The media-personality information search apparatus of claim 9,
wherein the program genre determining unit determines the program genre to be the first genre if a media personality name is presented in captions, and determines the program genre to be the second genre if a character name of a media personality is presented in captions.

11. The media-personality information search apparatus of claim 9,
wherein the program genre determining unit determines the program genre to be the first genre if the program is a sports program, a variety program, or a news program and determines the program genre to be the second genre if the program is a movie program or a drama program.

12. A media-personality information search system comprising:
a program keyword acquiring unit configured to acquire keywords contained in information on a program as program keywords;
a first program genre determining unit configured to determine whether or not a genre of the program is a predetermined genre;
a caption keyword acquiring unit configured to acquire keywords contained in captions of the program as caption keywords if the program genre is the predetermined genre;
a media personality information generating unit configured to generate information on media personalities in the program on the basis of the program keywords or the caption keywords;
an operation receiving unit configured to receive a search operation relating to a media personality;
a program searching unit configured to search for a program related to the media personality corresponding to the search operation, from the information on media personalities;
a second program genre determining unit configured to determine whether the genre of the searched program is the first genre or the second genre; and
a caption searching unit configured to search for the name of the media personality corresponding to the search operation from keywords contained in captions of the searched program if the program genre is the first genre, and search for the name of a character of the media personality corresponding to the search operation from keywords contained in the captions of the searched program if the program genre is the second genre, so as to specify a scene in which the media personality corresponding to the search operation appears.

13. A media personality information acquiring method comprising the steps of:
acquiring keywords contained in information on a program as program keywords;
determining whether or not a genre of the program is a predetermined genre;
acquiring keywords contained in captions of the program as caption keywords if the program genre is the predetermined genre; and
generating information on media personalities in the program on the basis of the program keywords or the caption keywords.

14. A media personality information search method comprising the steps of:
receiving a search operation relating to a media personality;
searching for a program related to the media personality corresponding to the search operation from information on media personalities in programs;
determining whether the genre of the searched program is a first genre or a second genre; and
searching for the name of the media personality corresponding to the search operation from keywords contained in captions of the searched program if the program genre is the first genre and searching for the name of a character of the media personality corresponding to the search operation from keywords contained in the caption of the searched program if the program genre is the second genre, so as to specify a scene in which the media personality corresponding to the search operation appears.

15. A program configured to cause a computer to execute the steps of:
acquiring keywords contained in information on a program as program keywords;
determining whether or not a genre of the program is a predetermined genre;
acquiring keywords contained in captions of the program as caption keywords if the program genre is the predetermined genre; and
generating information on media personalities in the program on the basis of the program keywords or the caption keywords.

16. A program configured to cause a computer to execute the steps of:
receiving a search operation relating to a media personality;
searching for a program related to the media personality corresponding to the search operation from information on media personalities in programs;
determining whether the genre of the searched program is a first genre or a second genre; and
searching for the name of the media personality corresponding to the search operation from keywords contained in captions of the searched program if the program genre is the first genre and searching for the name of a character of the media personality corresponding to the search operation from keywords contained in the caption of the searched program if the program genre is the second genre, so as to specify a scene in which the media personality corresponding to the search operation appears.
